(19) United States
(12) Patent Application Publication
(10) Pub. No.: US 2026/0063903 A1
(43) Pub. Date: Mar. 5, 2026

(54) EYEBALL TRACKING OPTICAL SYSTEM AND HEAD-MOUNTED DEVICE

(71) Applicant: BEIJING 7INVENSUN TECHNOLOGY CO., LTD., Beijing (CN)

(72) Inventors: Juanjuan SHANG, Beijing (CN); Wenbo FEI, Beijing (CN)

(73) Assignee: BEIJING 7INVENSUN TECHNOLOGY CO., LTD., Beijing (CN)

(21) Appl. No.: 18/878,038

(22) PCT Filed: Jun. 20, 2023
(86) PCT No.: PCT/CN2023/101520

§ 371 Date: Nov. 3, 2025

(30) Foreign Application Priority Data
Jun. 21, 2022 (CN) 202210706722.3

(51) Int. Cl. G02B 27/01; G02B 1/10; G02B 13/00; G02B 27/00

(52) U.S. Cl. CPC G02B 27/0172; G02B 1/10; G02B 13/003; G02B 13/007; G02B 13/008; G02B 27/0093; G02B 27/0176; G02B 2027/0138; G02B 2027/015

(57) ABSTRACT

An eyeball tracking optical system and a head-mounted device. The eyeball tracking optical system includes a light source module, a fixed-lens group module, a prism module, and an image acquisition module. In an optical path formed by photographing an eye image, at least one reflection prism is added at a front end of a light-sensitive surface of the image acquisition module.

The present disclosure claims priority of Chinese patent application no. 202210706722.3, filed to the CNIPA on 21 Jun. 2022 and entitled “Eyeball Tracking Optical System and Head-Mounted Device”, which is incorporated herein by reference in its entirety.

### TECHNICAL FIELD

The present disclosure relates to the technical field of eyeball tracking, and in particular, to an eyeball tracking optical system and a head-mounted device.

### BACKGROUND

Eyeball tracking technology can be implemented using an optical recording method. The principle of the optical recording method is: using an infrared camera to record eye movement of a subject, i.e. acquiring eye images capable of reflecting eye movement, and extracting eye features from the acquired eye images so as to establish an estimation model of a line of sight. The eye features may include a pupil position, a pupil shape, an iris position, an iris shape, an eyelid position, an eye corner position, a light spot position (or a Purkinje image), etc. The optical recording method includes a pupil-cornea reflection method. The principle of the pupil-cornea reflection method is: a near-infrared light source irradiates the eye, an infrared camera photographs the eye, and also photographs a reflection spot of the light source on the cornea, i.e. a light spot, thereby obtaining an eye image with a light spot.

Currently, virtual reality (VR) type helmets have a development tendency to a thin-thickness and foldable design, and thus, productization development is mostly carried out on the basis of compact display optical units. FIG. 1 is a structural schematic diagram of an eyeball tracking optical system provided by the prior art. In view of FIG. 1, in a near-eye eyeball tracking device, a camera 11 adopts a built-in reflection photographing method; light rays S0 emitted by a light source 12 are reflected by an eyeball 13; and reflected light rays S0′ transmit through an optical lens 14, and are reflected by a reflector 15 and then enter the camera 11, and finally present an eye image. FIG. 1 shows an optical path, from the eye to the camera 11, when photographing an eye image using a built-in reflection method. In such a method, the camera 11 is located between the optical lens 14 and the reflector 15, and thus there are great limitations in terms of the position and angle of the camera; some reflected light rays of the reflector 15 cannot enter the camera 11 due to the angle, resulting in a low utilization rate of the light-sensitive surface of the camera 11, and incomplete imaging of eye images.

### SUMMARY

The present disclosure provides an eyeball tracking optical system and a head-mounted device. In an optical path formed by photographing an eye image using a built-in reflection method, adding at least one reflection prism at a front end of a light-sensitive surface of a camera can achieve the effects of reducing the system size, prolonging the light path, and reducing the photographing angle of an image acquisition module, alleviating the problem of a low utilization rate of the light-sensitive surface of the image acquisition module, well alleviating the problem of incomplete acquisition of eye images, and improving the quality of imaging of eye images.

The present disclosure provides an eyeball tracking optical system, including a light source module, a fixed-lens group module, a prism module, and an image acquisition module;
the light source module is located at an edge of a side of the fixed-lens group module close to a user's eyeball, and the light source module is configured to emit a light ray with a preset wavelength to the user's eyeball; the light ray with the preset wavelength forms a reflected light ray after being reflected by the user's eyeball;
the fixed-lens group module at least includes a first fixed-lens and a second fixed-lens, the first fixed-lens and the second fixed-lens being sequentially arranged along a side far away from the user's eyeball, and the image acquisition module being located at an edge of a gap side between the first fixed-lens and the second fixed-lens;
the prism module includes at least one reflection prism, the at least one reflection prism being located at a front end of a light-sensitive surface of the image acquisition module; the reflected light ray penetrates through the first fixed-lens, is reflected by the second fixed-lens, then is reflected by the at least one reflection prism, and then enters the image acquisition module, and the image acquisition module is configured to generate an image of the user's eyeball.

Optionally, a reflection surface of the reflection prism is a flat surface.

Optionally, an included angle between the reflection surface of the reflection prism and a plane in which the light-sensitive surface of the image acquisition module is located is α, wherein 0°<α<90°.

Optionally, the reflection surface of the reflection prism is a concave surface.

Optionally, the reflection surface of the reflection prism includes an enhanced reflective film, and the enhanced reflective film is configured to increase an efficiency of reflection of the reflected light ray.

Optionally, the at least one reflection prism is fixedly arranged with the image acquisition module.

Optionally, the light source module includes an array infrared band light source configured to emit infrared band light rays in an array.

Optionally, the second fixed-lens includes an infrared cut filter configured to reflect the infrared band light rays emitted by the array infrared band light source to the prism module.

Optionally, the eyeball tracking optical system further includes a display screen;
the display screen is located on a side of the second fixed-lens far away from the user's eyeball, and the display screen is a multi-dimensional display screen configured to display a multi-dimensional image.

In a second aspect, the present disclosure further provides a head-mounted device, including a head-mounted apparatus and the described eyeball tracking optical system.

According to the eyeball tracking optical system provided by the present disclosure, in an optical path formed by photographing an eye image using the image acquisition module with the built-in reflection method, at least one reflection prism is added at the front end of the light-sensitive surface of the image acquisition module, such that the limited internal space is utilized to adjust the position and angle of the image acquisition module more flexibly, the system size can be reduced, the light path can be prolonged, and the photographing angle of the image acquisition module can be reduced, alleviating the problem of a low utilization rate of the light-sensitive surface of the image acquisition module, such that an eye imaging area is larger, alleviating the problem of incomplete acquisition of eye images, and improving the quality of imaging by a camera.

### BRIEF DESCRIPTION OF THE DRAWINGS

FIG. 1 is a structural schematic diagram of an eyeball tracking optical system provided by the prior art;

FIG. 2 is a structural schematic diagram of one eyeball tracking optical system provided by the present disclosure;

FIG. 3 is a structural schematic diagram of another eyeball tracking optical system provided by the present disclosure;

FIG. 4 is a structural schematic diagram of another eyeball tracking optical system provided by the present disclosure; and

FIG. 5 is a structural schematic diagram of another eyeball tracking optical system provided by the present disclosure.

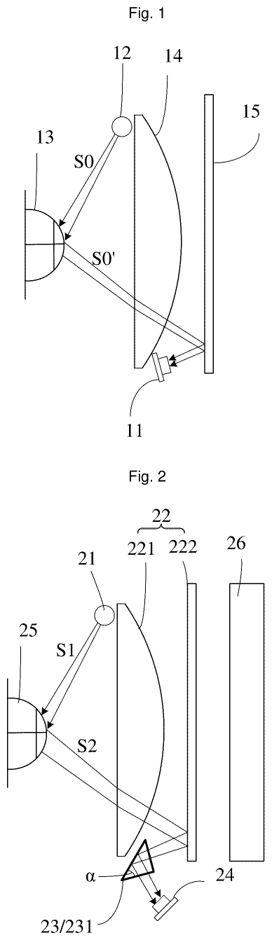

### DETAILED DESCRIPTION OF THE EMBODIMENTS

The present disclosure will be further described in details with reference to the drawings and the embodiments. It should be understood that the specific embodiments described herein are only used to explain the present disclosure but not to limit the present disclosure. In addition, it should be noted that, for easy description, the drawings only show some but not all structures related to the present disclosure.

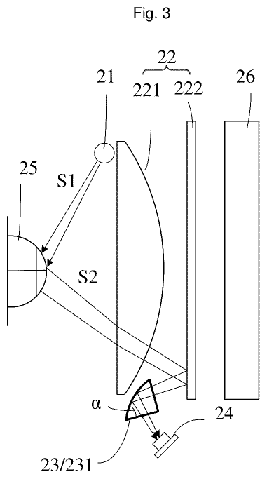

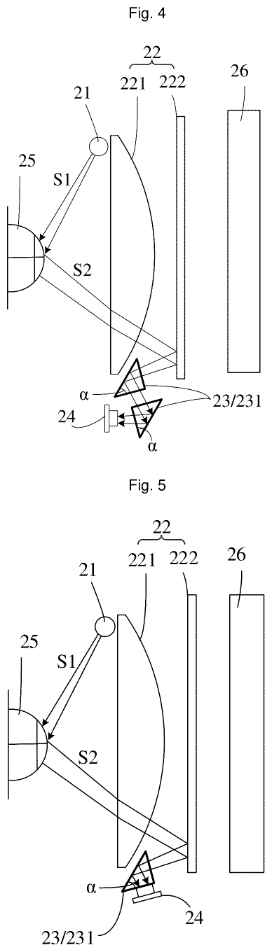

FIG. 2 is a structural schematic diagram of one eyeball tracking optical system provided by the present disclosure; FIG. 3 is a structural schematic diagram of another eyeball tracking optical system provided by the present disclosure; and FIG. 4 is a structural schematic diagram of another eyeball tracking optical system provided by the present disclosure. In view of FIG. 2 and FIG. 4, the present disclosure provides an eyeball tracking optical system. The system includes a light source module 21, a fixed-lens group module 22, a prism module 23, and an image acquisition module 24; the light source module 21 is located at an edge of a side of the fixed-lens group module 22 close to a user's eyeball 25, and the light source module 21 is configured to emit a light ray with a preset wavelength to the user's eyeball 25; the light ray with the preset wavelength forms a reflected light ray after being reflected by the user's eyeball 25; the fixed-lens group module 22 at least includes a first fixed-lens 221 and a second fixed-lens 222, the first fixed-lens 221 and the second fixed-lens 222 being sequentially arranged along a side far away from the user's eyeball 25, and the image acquisition module 24 being located at an edge of a gap side between the first fixed-lens 221 and the second fixed-lens 222; the prism module 23 includes at least one reflection prism 231, the at least one reflection prism 231 being located at a front end of a light-sensitive surface of the image acquisition module 24; the reflected light ray penetrates through the first fixed-lens 221, is reflected by the second fixed-lens 222, then is reflected by the at least one reflection prism 231, and then enters the image acquisition module 24, and the image acquisition module 24 is configured to generate an image of the user's eyeball 25.

Specifically, the eyeball tracking optical system provided by the present disclosure further includes a mounting frame (not shown in the drawings). In view of FIG. 2 and FIG. 4, the light source module 21, the fixed-lens group module 22, the prism module 23, and the image acquisition module 24 are fixedly arranged in the mounting frame. The light source module 21 includes at least one luminous light source which can emit a light ray S1 with a preset wavelength which can be received and reflected by the eye, such as a light ray in a visible light band or in an infrared band. The fixed-lens group module 22 at least includes the first fixed-lens 221 and the second fixed-lens 222, the first fixed-lens 221 and the second fixed-lens 222 being sequentially arranged along the side far away from the user's eyeball 25; the first fixed-lens 221 can be a Fresnel lens to protect other components and focus light; and the second fixed-lens 222 not only can transmit external light rays to the user's eye, but also can reflect the light rays emitted from the light source module 21, and is configured to be used for imaging by the image acquisition module 24. The image acquisition module 24 includes at least one image acquisition device, such as a camera, and is configured to receive the reflected light ray and generate eye images which are configured to be used for eye tracking and positioning. The light source module 21 is arranged at the edge of the side of the first fixed-lens 221 close to the user's eyeball 25, and the image acquisition module 24 is arranged at the edge of the gap side between the first fixed-lens 221 and the second fixed-lens 222, wherein the light source module 21 and the image acquisition module 24 can be located at the same side or different sides of the user's eyeball 25. The prism module 23 includes at least one reflection prism 231, the reflection prism 231 having a reflection surface. The reflection prism 231 uses the law of reflection and the law of refraction of light, i.e. when light is reflected in the same medium, the angle of incidence equals the angle of reflection; and when light travels from one medium into the other medium perpendicularly to the plane of the two media, refraction does not occur. As shown in FIG. 2 and FIG. 3, one reflection prism 231 is located at the front end of the light-sensitive surface of the image acquisition module 24; the light ray emitted by the light source module 21 forms the reflected light ray after being reflected by the user's eyeball; the reflected light ray penetrates through the first fixed-lens 221, is reflected by the second fixed-lens 222, then is reflected by the reflection surface of the reflection prism 231, and is received by the light-sensitive surface of the image acquisition module 24. As shown in FIG. 4, two reflection prisms 231 are combined and are located at the front end of the light-sensitive surface of the image acquisition module 24; the light ray emitted by the light source module 21 forms the reflected light ray after being reflected by the user's eyeball 25; the reflected light ray penetrates through the first fixed-lens 221, is reflected by the second fixed-lens 222, then is sequentially reflected by the reflection surfaces of the two combined reflection prisms 231, and is received by the light-sensitive surface of the image acquisition module 24. The image acquisition module 24 generates an image of the user's eyeball 25. In an optical path formed by photographing eye images using the image acquisition module 24 with built-in reflection method, adding at least one reflection prism 231 at the front end of the light-sensitive surface of the image acquisition module 24 can achieve the effects of prolonging the light path and reducing the photographing angle of the image acquisition module 24, and can fully use the light-sensitive surface of the image acquisition module 24, alleviating the problem of incomplete acquisition of eye images, and improving the quality of imaging by the camera; moreover, by adding the reflection prism 231, the image acquisition module 24 can be removed from the side between the first fixed-lens 221 and the second fixed-lens 222, the position of the image acquisition module 24 can be flexibly arranged, and the position of the image acquisition module 24 in the fixed-lens group module 22 can be omitted, further compressing the size of the eyeball tracking optical system, satisfying the requirements of compact display optical units for the structural design of eyeball tracking and iris recognition technology.

In conclusion, according to the eyeball tracking optical system provided by the present disclosure, in an optical path formed by photographing eye images using a camera with built-in reflection method, adding at least one reflection prism 231 at the front end of the light-sensitive surface of the camera can omit the position of the camera, and achieve the effects of reducing the system size, prolonging the light path, and reducing the photographing angle of the image acquisition module, alleviating the problem of a low utilization rate of the light-sensitive surface of the image acquisition module, allowing for a larger eye imaging area, alleviating the problem of incomplete acquisition of eye images, and improving the quality of imaging by the camera.

As a feasible implementation, still with reference to FIG. 2, optionally, a reflection surface of the reflection prism 231 is a flat surface. Using the flat reflection surface changes the propagation direction of the reflection light ray S2, and achieves the effects of prolonging the optical path and reducing the photographing angle of the image acquisition module 24, such that the light-sensitive surface of the image acquisition module 24 can receive the reflection light rays S2 reflected by the user's eyeball 25 as much as possible, alleviating the problem of a low utilization rate of the light-sensitive surface of the image acquisition module 24, allowing for the formation of complete eye images.

As a feasible implementation, still with reference to FIG. 3, optionally, the reflection surface of the reflection prism 231 is a concave surface. Configuring the reflection surface of the reflection prism 231 to be a concave surface can focus the reflected light rays S2, such that the light-sensitive surface of the image acquisition module 24 can receive more reflected light rays S2, improving brightness of eye imaging and completeness of eye imaging.

On the basis of the described embodiments, in view of FIG. 2 to FIG. 4, optionally, an included angle between the reflection surface of the reflection prism 231 and a plane in which the light-sensitive surface of the image acquisition module 24 is located is α, wherein 0°<α<90°.

Specifically, the reflection surface of the reflection prism 231 can be a flat or a concave surface, and the included angle α between the reflection surface of the reflection prism 231 and the plane in which the light-sensitive surface of the image acquisition module 24 is located is acute. When the reflection surface of the reflection prism 231 is a flat surface, preferably, α=45°. The propagation direction of the reflected light rays S2 can be changed by adjusting the included angle α between the reflection surface of the reflection prism 231 and the plane in which the light-sensitive surface of the image acquisition module 24 is located, such that the position of the image acquisition module 24 can be flexibly arranged, and the position of the image acquisition module 24 in the fixed-lens group module 22 can be omitted, further compressing the size of the eyeball tracking optical system.

Optionally, still with reference to FIG. 2 to FIG. 4, the dimensions of the reflection prism 231 meet 3 mm*3 mm*3 mm. The propagation direction of the reflected light rays S2 is adjusted using the small-sized reflection prism 231, such that the space occupied by the reflection prism is small, the position of the reflection prism can be flexibly changed, and the volume structure of the whole system is not affected, facilitating size compression of the eyeball tracking optical system.

Optionally, the reflection surface of the reflection prism 231 includes an enhanced reflective film, and the enhanced reflective film is configured to increase an efficiency of reflection of the reflected light ray. By additionally coating the reflection surface of the reflection prism 231 with the enhanced reflective film, as the enhanced reflective film includes a full-waveband reflection film, the efficiency of reflection of the reflected light rays S2 can be increased, such that more reflected light rays S2 can enter the image acquisition module 24, improving brightness and contrast of eyeball imaging, and improving the quality of imaging of eye images.

FIG. 5 is a structural schematic diagram of another eyeball tracking optical system provided by the present disclosure. Optionally, as shown in FIG. 5, the at least one reflection prism 231 is fixedly arranged with the image acquisition module 24.

Specifically, by fixing the reflection prism 231 with the front end of the image acquisition module 24, the reflection prism 231 can be closely attached to the light-sensitive surface of the image acquisition module 24, and position movement of the reflection surface of the reflection prism 231 and the light-sensitive surface of the image acquisition module 24 can be reduced, reducing shaking, ensuring the stability of eye imaging by the image acquisition module 24. Optionally, still with reference to FIG. 2 to FIG. 4, the reflection prism 231 can also have a certain distance from the light-sensitive surface of the image acquisition module 24, so as to flexibly adjust the position of the image acquisition module 24.

On the basis of the described embodiments, still with reference to FIG. 2 and FIG. 3, optionally, the light source module 21 includes an array infrared band light source configured to emit infrared band light rays in an array.

Specifically, the array infrared band light source is an array composed of several infrared light sources (700 nm to 1100 nm or a specific wave band), and emits infrared band light rays in an array. Using the array infrared band light source can provide light rays with uniform light spots, such that the light rays received by the user's eye have uniform energy, and the brightness of the imaging, on the image acquisition module 24, of the light rays reflected by the user's eye is comparatively uniform, alleviating the problem that the contrast of the brightness at an imaging edge is not obvious.

On the basis of the described embodiments, still with reference to FIG. 2 and FIG. 4, optionally, the second fixed-lens 222 includes an infrared cut filter configured to reflect the infrared band light rays emitted by the array infrared band light source to the prism module 23. The infrared cut filter refers to a lens allowing light rays in an infrared band to be reflected and light rays of other wavelengths to penetrate through. A precision optical coating technique is used to coat optical glass alternately with optical films with high and low refractive indexes, achieving an optical filter cutting infrared band light (700 nm to 1100 nm). The second fixed-lens 222 uses the infrared cut filter, such that more light rays emitted by the array infrared band light source can be reflected to the image acquisition module 24, improving a light ray utilization rate, and allowing for the formation of complete eye images.

On the basis of the described embodiments, still with reference to FIG. 2 and FIG. 3, optionally, the eyeball tracking optical system further includes a display screen 26; and the display screen 26 is located on a side of the second fixed-lens 222 far away from the user's eyeball 25, and the display screen 26 is a multi-dimensional display screen 26 configured to display a multi-dimensional image.

Specifically, the display screen 26 can be an organic light emitting diode display screen (OLED), a light emitting diode display screen (LED), a micro light emitting diode display screen (Micro LED), etc., and displays a colored or black-and-white picture; the display screen 26 is arranged on the side of the second fixed-lens 222 far away from the user' eyeball 25, and a multi-dimensional image emitted by the display screen 26 passes through the second fixed-lens 222 and the first fixed-lens 221 sequentially and then reaches the user's eye for imaging.

On the basis of the same inventive concept, the present disclosure provides a head-mounted device, including a head-mounted apparatus and the eyeball tracking optical system provided by the described embodiments; and the head-mounted device can be used in user-wearable eyeball tracking and iris recognition applications.

It should be noted that the content above only relates to preferred embodiments of the present disclosure and technical principles applied thereto. A person skilled in the art will appreciate that the present disclosure is not limited to the specific embodiments described herein and that various obvious variations, rearrangements, combinations, and substitutions are possible for a person skilled in the art without departing from the scope of the present disclosure. Therefore, although the present disclosure is described in detail through the embodiments above, the present disclosure is not limited to the embodiments above, and can further include more other equivalent embodiments without departing from the concept of the present disclosure. The scope of the present disclosure is determined by the scope of the appended claims.

1. An eyeball tracking optical system, comprising a light source module, a fixed-lens group module, a prism module, and an image acquisition module;
the light source module is located at an edge of a side of the fixed-lens group module close to a user's eyeball, and is configured to emit a light ray with a preset wavelength to the user's eyeball; the light ray with the preset wavelength forms a reflected light ray after being reflected by the user's eyeball;
the fixed-lens group module at least comprises a first fixed-lens and a second fixed-lens, the first fixed-lens and the second fixed-lens being sequentially arranged along a side far away from the user's eyeball, and the image acquisition module being located at an edge of a gap side between the first fixed-lens and the second fixed-lens;
the prism module comprises at least one reflection prism, the at least one reflection prism being located at a front end of a light-sensitive surface of the image acquisition module; the reflected light ray penetrates through the first fixed-lens, is reflected by the second fixed-lens, then is reflected by the at least one reflection prism, and then enters the image acquisition module, and the image acquisition module is configured to generate an image of the user's eyeball.

2. The eyeball tracking optical system according to claim 1, wherein a reflection surface of the reflection prism is a flat surface.

3. The eyeball tracking optical system according to claim 1, wherein a reflection surface of the reflection prism is a concave surface.

4. The eyeball tracking optical system according to claim 1, wherein an included angle between a reflection surface of the reflection prism and a plane in which the light-sensitive surface of the image acquisition module is located is α, wherein 0°<α<90°.

5. The eyeball tracking optical system according to claim 1, wherein a reflection surface of the reflection prism comprises an enhanced reflective film, and the enhanced reflective film is configured to increase an efficiency of reflection of the reflected light ray.

6. The eyeball tracking optical system according to claim 1, wherein the at least one reflection prism is fixedly arranged with the image acquisition module.

7. The eyeball tracking optical system according to claim 1, wherein the light source module comprises an array infrared band light source configured to emit infrared band light rays in an array.

8. The eyeball tracking optical system according to claim 7, wherein the second fixed-lens comprises an infrared cut filter configured to reflect the infrared band light rays emitted by the array infrared band light source to the prism module.

9. The eyeball tracking optical system according to claim 1, further comprising a display screen;
the display screen is located on a side of the second fixed-lens far away from the user's eyeball, and the display screen is a multi-dimensional display screen configured to display a multi-dimensional image.

10. A head-mounted device, comprising a head-mounted apparatus and the eyeball tracking optical system according to claim 1.

11. The head-mounted device according to claim 10, wherein a reflection surface of the reflection prism is a flat surface.

12. The head-mounted device according to claim 10, wherein a reflection surface of the reflection prism is a concave surface.

13. The head-mounted device according to claim 10, wherein an included angle between a reflection surface of the reflection prism and a plane in which the light-sensitive surface of the image acquisition module is located is α, wherein 0°<α<90°.

14. The head-mounted device according to claim 10, wherein a reflection surface of the reflection prism comprises an enhanced reflective film, and the enhanced reflective film is configured to increase an efficiency of reflection of the reflected light ray.

15. The head-mounted device according to claim 10, wherein the at least one reflection prism is fixedly arranged with the image acquisition module.

16. The head-mounted device according to claim 10, wherein the light source module comprises an array infrared band light source configured to emit infrared band light rays in an array.

17. The head-mounted device according to claim 16, wherein the second fixed-lens comprises an infrared cut filter configured to reflect the infrared band light rays emitted by the array infrared band light source to the prism module.

18. The head-mounted device according to claim 10, further comprising a display screen;
the display screen is located on a side of the second fixed-lens far away from the user's eyeball, and the display screen is a multi-dimensional display screen configured to display a multi-dimensional image.
